(19) United States
(12) Patent Application Publication
(10) Pub. No.: US 2006/0219509 A1
(43) Pub. Date: Oct. 5, 2006

(54) System and method for controlling engagement of a clutch

(75) Inventors: Todd Ryan Kabrich, Creve Coeur, IL (US); Richard Brookes League, Peoria, IL (US); Vaibhav Hasmukhlal Shah, Peoria, IL (US); Andrew William Sloan, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/094,381

(22) Filed: Mar. 31, 2005

(51) Int. Cl. B60K 41/22

(52) U.S. Cl. 192/3.63; 192/103 F

(57) ABSTRACT

A method for controlling engagement of a clutch in a work machine includes determining a relative speed of the clutch of the work machine and selectively adjusting an actuation pressure applied to the clutch based at least in part on the clutch relative speed.

### TECHNICAL FIELD

The present disclosure relates generally to a method for controlling the actuation of a clutch in a work machine, and more particularly to a method for controlling the fluid actuation of a clutch in a work machine.

### BACKGROUND

Work machines utilize clutches for connecting input and output mechanisms within the power train of the work machine. A simple clutch has two friction plates which engage and disengage with one another to transfer torque. One plate, the input plate, rotates and can be selectively engaged with the second plate, the output plate, to transmit the torque to drive train components coupled to the second plate. A fast engagement between the two plates can result in a harsh “jerk” caused by the sudden spike in torque that is transmitted through the drive train of the work machine. This “jerk” reduces the life of the components in the drive train. Furthermore, the work machine operator may find this “jerk” uncomfortable and the work machine difficult to operate precisely.

In many work machines, the flow of a pressurized fluid, such as high pressure engine or transmission oil, controls the engagement of the clutch. An electronic control unit controls the operation of a fluid actuated clutch by regulating the flow of the pressurized fluid to the movable components of the clutch. Through an electronic control system, the electronic control unit is connected to one or more solenoid operated valves. The electronic control unit regulates the flow of the pressurized fluid by selectively activating the solenoid valves. Utilizing fluid actuation enables the electronic control unit to slowly build up pressure on the movable components of the clutch. This slow build up of pressure allows for a smoother engagement of the clutch.

Initially, the two plates within a clutch rotate at different speeds. For example, after first starting the work machine, the input plate may be rotating at the speed of the engine and the output plate may be stationary. Typically, controlling the solenoid operated valve allows the output plate to be slowly brought into engagement with the first clutch so that the “jerk” is minimized. To do this, the engaging surfaces of the plates within a clutch may include a friction material. As the output plate gets closer to the input plate, more and more pressure will build within the input plate. As the plates get closer together, more and more torque is transferred causing the output plate to increase in speed. Eventually, enough friction material will contact causing the output plate to rotate at the same speed as the input plate. This is referred to as the “lock up” friction point. This description illustrates the relationship between the coefficient of friction between the two clutch plates and the clutch relative speed: as the coefficient of friction increases, the clutch relative speed decreases. At “lock up,” the coefficient of friction is at its maximum value.

U.S. Pat. No. 5,737,979 discloses a method for calibrating the amount of time necessary to build pressure in a fluid actuated clutch such that the two plates of the clutch engage one another to reduce the harshness of engagement. This time is typically determined by the manufacturer and preprogrammed into the electronic control unit of the work machine. One problem with this method, however, is that the clutch “jerk” still occurs. This is because the “jerk” is related to the amount of pressure being applied to the clutch. The greater the pressure applied to the clutch at “lock-up,” the greater the “jerk” occurring at “lock-up.” In addition, this proposed solution does not take into account the variations in timing and performance caused by the wear of components through continued use.

The method and apparatus of the present disclosure solves one or more of the problems set forth above.

### SUMMARY OF THE DISCLOSURE

In accordance with one exemplary embodiment, a method for controlling engagement of a clutch in a work machine is disclosed. The method includes determining a relative speed of the clutch of the work machine and selectively adjusting an actuation pressure applied to the clutch based at least in part on the clutch relative speed.

In accordance with another exemplary embodiment of the present disclosure, a method for controlling engagement of a clutch in a work machine includes determining a transmission ratio of the work machine. The method further includes selectively adjusting an actuation pressure applied to the clutch based at least in part on the transmission relative speed.

In accordance with yet another exemplary embodiment of the present disclosure, a method for controlling engagement of a clutch in a work machine includes applying a first set of actuation pressures to the clutch for a majority of clutch engagement. The method also includes applying a second set of actuation pressures to the clutch after the first set, the second set of clutch actuation pressures being less than a maximum clutch actuation pressure of the first set.

In accordance with another exemplary embodiment of the present disclosure, a system for controlling the engagement of at least one clutch in a transmission is disclosed. The system includes at least one electronic control unit configured to control engagement of the at least one clutch by determining a relative speed of the at least one clutch and selectively adjusting an actuation pressure applied to the at least one clutch based at least in part on the clutch relative speed.

### BRIEF DESCRIPTION OF THE DRAWINGS

FIG. 1. is a diagrammatic representation of a power train portion of a work machine for use with the present disclosure;

FIG. 2 is a diagrammatic representation of the transmission of the work machine of FIG. 1;

FIG. 3A is a chart illustrating the relationship between clutch relative speed and time in accordance with the present disclosure;

FIG. 3B is a chart illustrating the relationship between transmission ratio and time in accordance with the present disclosure;

FIG. 3C is a chart illustrating the relationship between pressure and time in accordance with the present disclosure; and

FIG. 4 is a flowchart illustrating an exemplary method for controlling the actuation of a clutch in a work machine in accordance with the present disclosure.

### DETAILED DESCRIPTION

Reference will now be made in detail to exemplary embodiments of the disclosure illustrated in the accompanying drawings. Wherever possible, the same reference numbers will be used throughout the drawings to refer to the same or like parts.

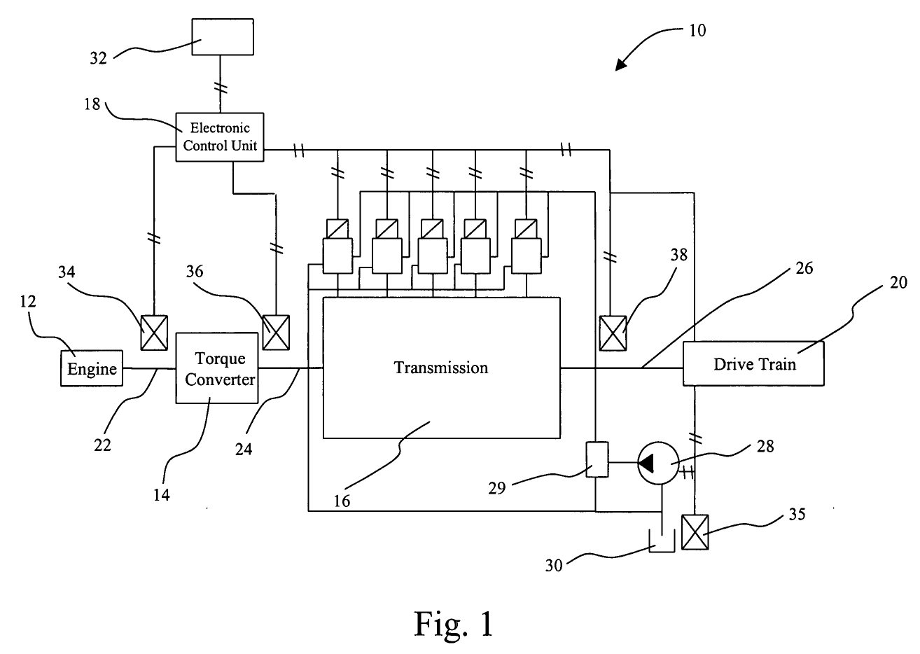

A power train portion 10 of a work machine utilizing an automatic transmission is diagrammatically illustrated in FIG. 1. The power train portion 10 may include an engine 12, a torque converter 14, a transmission 16, an electronic control unit 18, and a drive train 20. A drive shaft 22 may connect the engine 12 to the torque converter 14. An input shaft 24 may connect the torque converter 14 to the transmission 16. An output shaft 26 may connect the transmission 16 to the drive train 20. The power train portion 10 may also include a pump 28 for supplying high pressure fluid to components within the work machine. The pump 28 receives fluid from a reservoir 30. The power train portion 10 may also include a relief valve 29 downstream from the pump 28, for controlling the output pressure of the pump 28. It should be understood, however, that the method disclosed herein may be used with many different types of work machines. For example, the method disclosed here may be utilized in heavy duty trucks, motorgraders, and bucket loaders.

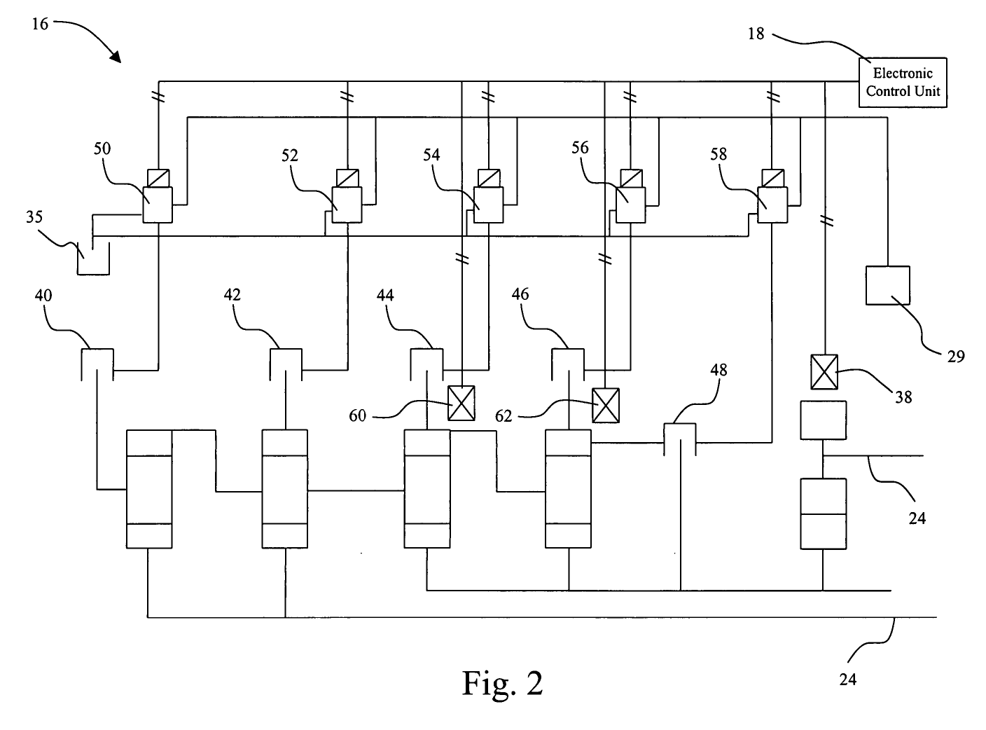

The electronic control unit 18 may receive input from an operator selector sensor system 32 representative of at least the direction of travel and/or the gear ratio desired by the operator of the work machine 10. The operator selector sensor system 32 may include, but is not limited to, a gear shift position sensor and an accelerator position sensor (not shown). The electronic control unit 18 may also receive inputs from various other sensors indicative of the desired or actual operating parameters of the work machine 10 including an engine speed sensor 34, a first speed sensor 36, a second speed sensor 38, a fluid reservoir temperature sensor 35, a first intermediate speed sensor 60 positioned between a speed clutch 44 and a speed clutch 46 (FIG. 2), and a second intermediate speed sensor 62 positioned between the speed clutch 46 and a speed clutch 48 (FIG. 2). These sensors may be of the common electrical type known in the art. It should be understood that the use of alternative type sensors may be utilized and that alternative placement of the sensors is possible.

One possible example of the transmission 16 is shown in FIG. 2. It should be understood that other automatic transmission arrangements are possible for use with the present disclosure. The transmission 16 may include five fluid actuated clutches 40, 42, 44, 46, and 48. The clutch 40 is the forward direction clutch and clutch 42 is the reverse direction clutch. As mentioned above, the clutches 44, 46, and 48 are various speed clutches. To operate the transmission 16 using this arrangement requires engaging either forward direction clutch 40 or reverse direction clutch 42. The clutches 40, 42, 44, 46, and 48 may be of the type commonly found in work machines and may include one input plate and one output plate or another configuration as is well known in the art. The speed clutches 44, 46, or 48 may be selectively engaged and disengaged to create various gear ratios as will be explained in more detail below.

Five solenoid operated clutch control valves (hereinafter referred to as “solenoid control valves”) 50, 52, 54, 56, and 58 may be provided for selectively engaging and disengaging a corresponding clutch 40, 42, 44, 46, and 48. Each solenoid control valve 50, 52, 54, 56, and 58 may be fluidly connected to receive high pressure fluid from the pump 28. The solenoid control valves 50, 52, 54, 56, and 58 may be connected to the electronic control unit 18. The electronic control unit controls the actuation of the solenoid control valves 50, 52, 54, 56, and 58. It should be understood that alternative fluid configurations are possible for use with the present disclosure. It should also be understood that other types of clutch control valves, such as piezoelectric driven control valves, may be used with the present disclosure.

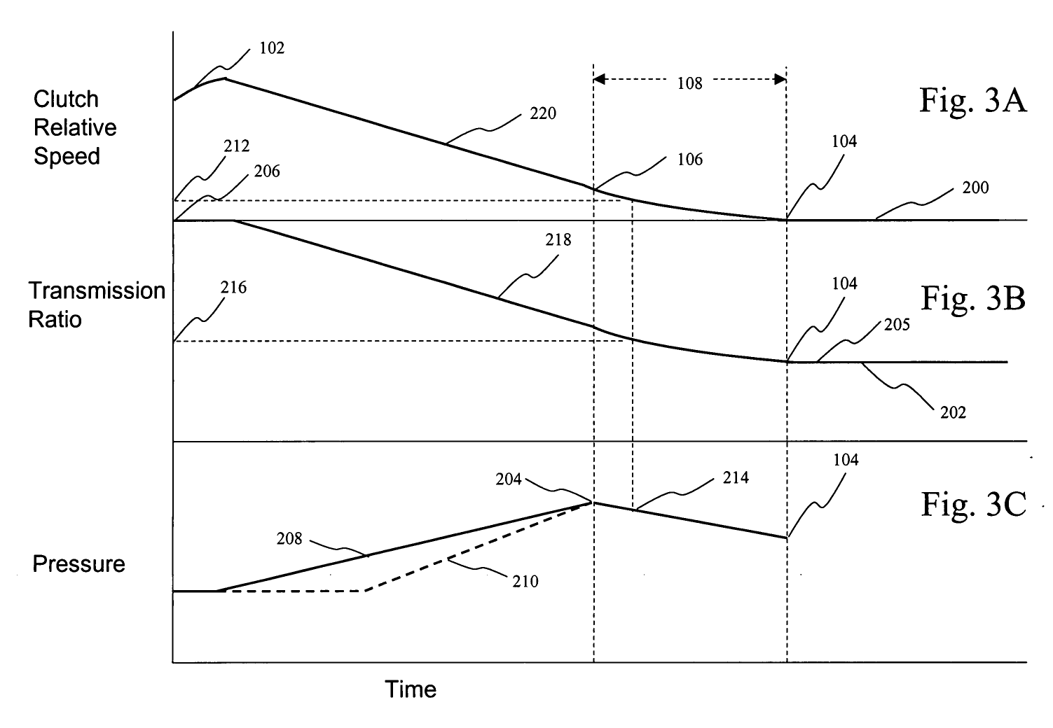

The electronic control unit 18 may include a microprocessor (not shown) for performing any necessary calculations, for receiving input from the various sensors, and for controlling the operation of the solenoid control valves 50, 52, 54, 56, and 58. Alternatively, more than one microprocessor could be used. It should be understood that the use of alternative type sensors is contemplated and that alternative placement of the sensors is also contemplated. Based on the various inputs described above, the microprocessor controls and selects the various gear ratios. The methods that are the subject of this disclosure will be discussed in more detail below in connection with FIGS. 3-5.

### INDUSTRIAL APPLICABILITY

The electronic control unit 18 controls the operation of the transmission 16 by controlling the engagement of one or more gears in the transmission 16. To engage a particular gear, the electronic control unit 18 selectively engages and disengages clutches 40, 42, 44, 46, and 48. To select the reverse gear, for example, the electronic control unit 18 may selectively engage the reverse direction clutch 42 and the speed clutch 44 and selectively disengage the forward direction clutch 40 and the speed clutches 46 and 48. The electronic control unit 18 can selectively and simultaneously engage and disengage clutches 40, 42, 44, 46, and 48 as necessary to achieve a particular gear combination corresponding to a desired transmission output. It should be understood that other possible methods for selecting the appropriate gears may be utilized with the transmission 16.

To engage a particular clutch, forward direction clutch 40 for example, the electronic control unit 18 sends a signal to the corresponding solenoid control valve, here solenoid control valve 50. Based on the signal, the solenoid control valve 50 controls the application of pressurized fluid to the clutch 40. Each different signal from the electronic control unit 18 to the solenoid control valve 50 may be indicative of a different fluid pressure to-be applied to the clutch 40. Once sufficient fluid pressure has been applied to the clutch 40, the input plate and output plate will “lock-up” and full torque can be transferred from the input side of the clutch 40 to the output side of the clutch 40. Here, “lock up” means the rotational speed of the clutch input shaft is equal to the rotational speed of the clutch output shaft taking into account the selected gearing. It should be understood that the electronic control unit 18 can selectively open and close the solenoid control valves 50, 52, 54, 56, and 58 to apply pressure in a similar manner to any clutch 40, 42, 44, 46, and 48.

In addition to controlling the engagement and disengagement of the clutches 40, 42, 44, 46, and 48, the electronic control unit 18 can continuously calculate a transmission ratio or transmission reduction by comparing the input speed of the transmission to the output speed of the transmission. For example, the electronic control unit 18 can calculate a transmission ratio using the sensed transmission input speed from the first speed sensor 36 and the sensed transmission output speed from the second speed sensor 38. Each possible gear combination has a corresponding transmission ratio value. For example, if the reverse direction clutch 42 and the speed clutch 44 are engaged, the transmission ratio value can be identified by the electronic control unit 18 as corresponding to an engagement of these particular clutches. To achieve this, the electronic control unit 18 may contain a transmission ratio profile including the transmission ratio values for each possible gear engagement. An exemplary transmission ratio profile 202 is illustrated in FIG. 3B showing transmission ratio versus time. When the electronic control unit 18 opens and closes the solenoid control valves 50, 52, 54, 56 and 58 to change from one gear combination to another, the transmission ratio will transition between two values (205, 206). This transition is identified as 218 in FIG. 3B and occurs until the clutches being engaged have “locked-up.” At this point the transmission ratio reaches a constant or steady state corresponding to a particular transmission ratio value 206.

In addition to, or alternatively, the electronic control unit 18 may continuously calculate a clutch relative speed by comparing a clutch input speed to a clutch output speed. Here, the clutch relative speed may be determined by comparing the clutch input speed from, for example, the first speed sensor 36, the first intermediate speed sensor 60, or the second intermediate speed sensor 62, with the clutch output speed from, for example, the first intermediate speed sensor 60, the second intermediate speed sensor 62, or the second speed sensor 38 depending on the particular clutch examined. For example, to determine the clutch relative speed for clutch 44, the first speed sensor 36 would sense the clutch input speed and the first intermediate speed sensor 60 would sense the clutch output speed. Alternatively, the electronic control unit 18 may calculate a clutch relative speed in another manner known in the art.

In addition to FIGS. 3A-3B, the electronic control unit 18 may contain a pressure profile 204 (FIG. 3C) as will be discussed below in more detail. The pressure profile 204 illustrates pressure versus time.

As discussed above, the electronic control unit 18 controls the fluid pressure applied to the clutch and thus the actuation characteristics of the clutch. An exemplary clutch relative speed profile 200 is illustrated in FIG. 3A showing clutch relative speed versus time. With reference to engagement of clutch 40, the electronic control unit 18 determines the clutch relative speed and/or transmission ratio using the appropriate sensors. Before pressure is applied to clutch 40, the clutch relative speed will be far from zero as shown at 102 in FIG. 3A. This means that the input speed, the speed of the first plate in the clutch, is much higher than the output speed, the speed of the second plate in the clutch. The transmission ratio will be a constant value corresponding to a particular gear ratio as shown at 206 in FIG. 3B. To engage clutch 40, the electronic control unit 18 sends a signal to the solenoid control valve 50. In response to the signal from the electronic control unit 18, the solenoid control valve 50 is actuated to increase the amount of pressurized fluid flowing to the clutch 40. The increasing pressure applied to clutch 40 is shown at 208 in FIG. 3C. Other pressure profiles may be utilized with the present disclosure. For example, the pressure may increase at a different rate as shown at 210 in FIG. 3C. As the two clutch plates engage one another, the relative speed of the clutch and the transmission ratio enter a transient condition (220, 218) as the friction between the two plates increases. Increasing the friction between the two plates-in the clutch eventually leads to “lock-up” as shown at 104 in FIGS. 3A-3C, where the clutch relative speed is zero and the transmission ratio becomes constant corresponding to a particular gear ratio.

According to the present disclosure, the electronic control unit 18 may begin to reduce the amount of pressure applied to the clutch at a predetermined point shown at a point 106 in FIGS. 3A-3C prior to “lock-up.” For each calculated clutch relative speed and/or transmission ratio calculated between the point 106 and the “lock-up” point 104, the electronic control unit 18 continues to reduce the amount of pressure applied to the clutch. The area between the predetermined point 106 and the “lock-up” point 104 is known as a predetermined range 108. The point 106 may be determined by the manufacturer through testing of the particular clutch or transmission and friction materials used. To determine the appropriate pressure amount, the electronic control unit 18 continuously calculates the clutch relative speed and/or transmission ratio and then determines a desired clutch pressure amount using the pressure reference profile 204 in FIG. 3C stored within the electronic control unit 18. For example, if the electronic control unit 18 calculates a clutch relative speed as shown at point 212 in FIG. 3A, the electronic control unit can determine a corresponding clutch actuation pressure from FIG. 3C, in this case, the clutch actuation pressure corresponding to the point 214. Alternatively, if the electronic control unit 18 calculates a transmission ratio value shown at point 216 in FIG. 3B, the electronic control unit 18 can find a corresponding clutch actuation pressure shown at point 214 in FIG. 3C.

By reducing the pressure applied to the clutch as the clutch relative speed approaches zero, the electronic control unit 18 can lower the amount of “jerk” occurring at “lock-up.” Furthermore, the present disclosure will continue to reduce this “jerk” as the friction material on the clutch plates wears through continued use because the pressure reduction amount is based on measured input and output speeds that will change with the loss of friction material.

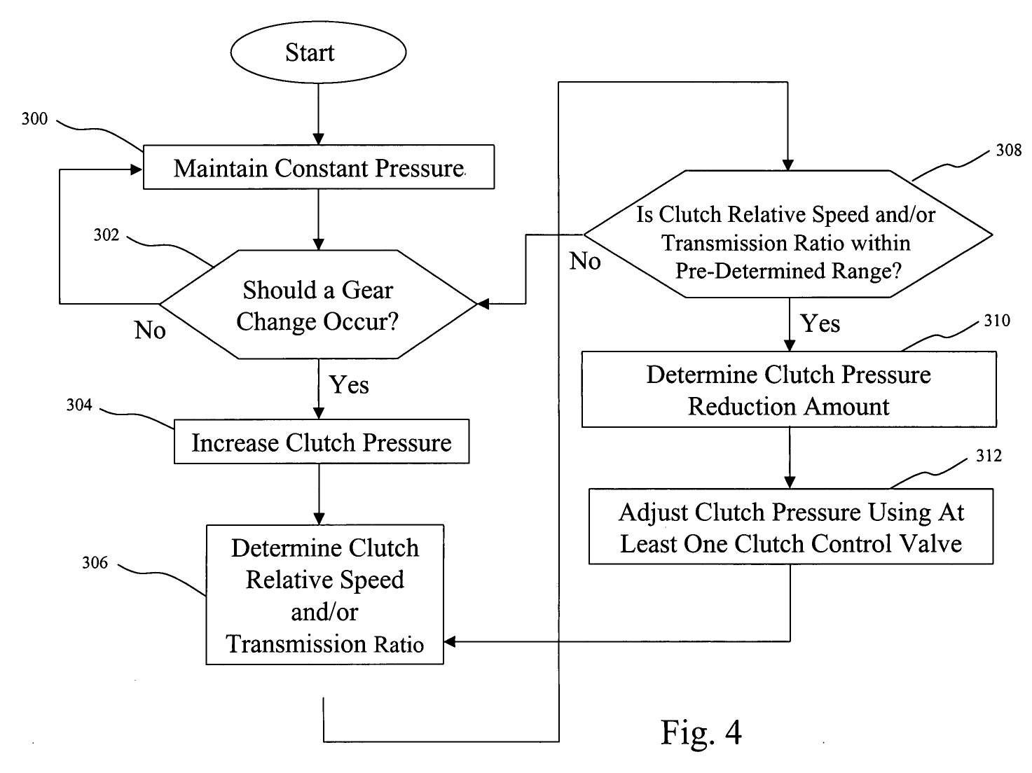

The flow chart of FIG. 4 illustrates an exemplary method for controlling the actuation of a clutch in a work machine. First, the electronic control unit 18 applies constant pressure to the clutch. (Step 300). To do this, the electronic control unit 18 sends a signal to one or more of the solenoid control valve 50, 52, 54, 56, and 58 so that the solenoid control valve applies pressure to one or more of the clutches 40, 42, 44, 46 and 48 by controlling the amount of pressurized fluid flowing to the corresponding clutch. Next, the electronic control unit 18 calculates the clutch relative speed and/or transmission relative speed. Based at least on the clutch relative speed or transmission relative speed, the electronic control unit 18 determines whether a gear change should occur by referencing stored data. (Step 302). If the electronic control unit 18 determines that a gear change should not occur, the electronic control unit 18 returns to Step 300, maintaining constant pressure.

If the electronic control unit 18 determines that a gear change should occur, the electronic control unit 18 sends a signal to one or more solenoid control valves 50, 52, 54, 56 and 58. In response, the solenoid control valve 50, 52, 54, 56 and 58 will increase the amount of pressurized fluid flowing to its corresponding clutch 40, 42, 44, 46, and 48. (Step 304 and 208 in FIG. 3C). Next, the electronic control unit 18 determines the new clutch relative speed and/or transmission relative speed. (Step 306). The electronic control unit next determines whether the new value of the clutch relative speed and/or new transmission ratio value is within the predetermined range 108. (Step 308). If the clutch relative speed and/or transmission ratio is not within the predetermined range 108, the electronic control unit 18 returns to Step 302, determining whether a gear change should occur. If the clutch relative speed and/or transmission ratio is within the predetermined range 108, the electronic control unit 18 next determines the appropriate pressure for this specific clutch relative speed and/or transmission ratio using the pressure profile 204 from FIG. 3C. (Step 310). For each calculated clutch relative speed and/or transmission relative speed, the electronic control unit 18 finds a corresponding clutch actuation pressure from the pressure profile 204 in FIG. 3C. Next, the electronic control unit 18 adjusts the clutch pressure. (Step 312). In this example, the electronic control unit 18 could adjust one or more solenoid control valves 50, 52, 54, 56, and 58 to adjust the pressure applied to a corresponding clutch 40, 42, 44, 46, and 48. Finally, the electronic control unit 18 returns to Step 306 and determines the new clutch relative speed and/or transmission relative speed. As noted above, the electronic control unit 18 can use the method disclosed here for one clutch at a time, or on multiple clutches at the same time.

Other embodiments of the disclosure will be apparent to those skilled in the art from consideration of the specification and practice of the disclosure discussed herein. It is intended that the specification and examples be considered as exemplary only, with a true scope and spirit of the disclosure being indicated by the following claims and their equivalents.

What is claimed is:

1. A method for controlling engagement of a clutch in a work machine, comprising:
determining a relative speed of the clutch of the work machine;
selectively adjusting an actuation pressure applied to the clutch based at least in part on the clutch relative speed.

2. The method of claim 1, wherein the determining the clutch relative speed includes measuring an input speed of the clutch and measuring an output speed of the clutch, and comparing the clutch output speed to the clutch input speed.

3. The method of claim 2, wherein the selectively adjusting the clutch actuation pressure includes determining a clutch actuation pressure as a function of the clutch relative speed and adjusting a signal to a clutch control valve based on the determined clutch actuation pressure.

4. The method of claim 3, wherein the clutch is a fluid actuated clutch, and the clutch control valve is a solenoid actuated control valve.

5. The method of claim 4, wherein the selectively adjusting the clutch actuation pressure includes selectively applying a plurality of signals to the solenoid actuated control valve to vary the clutch actuation pressure.

6. The method of claim 5, wherein the measuring the clutch input speed includes receiving a signal at a control unit from at least one clutch input speed sensor associated with the work machine.

7. The method of claim 6, wherein the measuring the clutch output speed includes receiving a signal at a control unit from at least one speed sensor associated with the work machine.

8. A method for controlling engagement of a clutch in a work machine, comprising:
determining a transmission ratio of the work machine; and
selectively adjusting an actuation pressure applied to the clutch based at least in part on the transmission relative speed.

9. The method of claim 8, wherein the determining the transmission ratio includes determining at least one transmission input speed and determining at least one transmission output speed.

10. The method of claim 9, wherein the selectively adjusting the clutch actuation pressure includes determining a clutch actuation pressure as a function of the transmission ratio and adjusting a signal to a clutch control valve based on the determined clutch actuation pressure.

11. The method of claim 10, wherein the clutch is a fluid actuated clutch, and the clutch control valve is a solenoid actuated control valve.

12. The method of claim 1 1, wherein the selectively adjusting the clutch actuation pressure includes selectively applying a plurality of signals to the solenoid actuated control valve to vary the clutch actuation pressure.

13. The method of claim 12, wherein the determining the transmission input speed includes receiving a signal at a control unit from at least one speed sensor associated with the work machine.

14. The method of claim 13, wherein the determining the transmission output speed includes receiving a signal at a control unit from at least one speed sensor-associated with the work machine.

15. A method for controlling engagement of a clutch in a work machine, comprising:
applying a first set of actuation pressures to the clutch for a majority of clutch engagement; and
applying a second set of actuation pressures to the clutch after the first set, the second set of clutch actuation pressures being less than a maximum clutch actuation pressure of the first set.

16. The method of claim 15, wherein the second set of clutch actuation pressures is applied when a clutch relative speed approaches a predetermined value.

17. The method of claim 16, wherein the clutch relative speed is determined by measuring an input speed of the clutch and measuring an output speed of the clutch, and comparing the clutch output speed to the clutch input speed.

18. The method of claim 17, wherein the applying the second set of clutch actuation pressures includes determining a clutch actuation pressure as a function of the clutch relative speed and selectively adjusting a signal to a clutch control valve based on the determined clutch actuation pressure.

19. The method of claim 18, wherein the clutch is a fluid actuated clutch, and the clutch control valve is a solenoid actuated control valve.

20. The method of claim 19, wherein the selectively adjusting the signal to a clutch control valve includes selectively applying a plurality of signals to the solenoid actuated control valve to vary the clutch actuation pressure.

21. The method of claim 20, wherein the measuring the clutch input speed includes receiving a signal at a control unit from at least one speed sensor associated with the work machine.

22. The method of claim 21, wherein the measuring the clutch output speed includes receiving a signal at a control unit from at least one speed sensor associated with the work machine.

23. The method of claim 22, wherein the second set of clutch actuation pressures is applied when a transmission ratio approaches a predetermined value.

24. The method of claim 23, wherein a transmission ratio is determined by determining at least one transmission input speed and determining at least one transmission output speed.

25. A system for controlling the engagement of at least one clutch in a transmission, the system comprising:
at least one electronic control unit configured to control engagement of the at least one clutch by:
determining a relative speed of the transmission; and
selectively adjusting an actuation pressure applied to the at least one clutch based at least in part on the transmission relative speed.

26. The system of claim 25, wherein the at least one electronic control unit is configured to receive a signal from at least one speed sensor and a signal from at least one speed sensor.

27. The system of claim 26, wherein the system further includes at least one clutch control valve responsive to signals from the at least one electronic control unit.

28. The system of claim 27, wherein the at least one clutch is a fluid actuated clutch.
